(19) United States
(12) Patent Application Publication
(10) Pub. No.: US 2006/0200510 A1
(43) Pub. Date: Sep. 7, 2006

(54) Precision cordic processor

(76) Inventors: Cindy Chun Wang, Newark, CA (US); Xiangyang Xu, San Jose, CA (US); Xiaochun Chen, Shanghai (CN)

Correspondence Address: FELIX L. FISCHER, ATTORNEY AT LAW, 1607 MISSION DRIVE, SUITE 204, SOLVANG, CA, 93463, US

(21) Appl. No.: 11/346,754

(22) Filed: Jan. 30, 2006

Related U.S. Application Data
(60) Provisional application No. 60/648,762, filed on Jan. 31, 2005.

(51) Int. Cl. G06F 15/00

(52) U.S. Cl. 708/200

(57) ABSTRACT

A CORDIC angle calculator for a baseband IC receiver incorporates a CORDIC algorithm calculating processor with an input scaling means receiving input data, scaling the input data and providing it to the CORDIC processor. An output scaling means receives output data from the CORDIC processor and rescales the output data to provide a calculated angle. In an exemplary embodiment, the input scaling means includes means for shifting the input data for bit reduction and providing a shift signal corresponding to the input data shift and wherein the output scaling means is responsive to the shift signal.

### REFERENCE TO RELATED APPLICATIONS

This application relies on the priority of U.S. Provisional Application Ser. No. 60/648,762 filed on Jan. 31, 2005 having the same title as the present application.

### FIELD OF THE INVENTION

This invention relates generally to the field of frequency offset correction in signal demodulation and, more particularly, to an improved coordinate rotation digital computer (CORDIC) for rotation angle calculation.

### BACKGROUND OF THE INVENTION

Legacy communications systems such as the Personal Handy-phone System (PHS) are configured to be simple and low cost. Differential demodulation has been adopted based on the technological constraints present at the time of designing these systems for baseband demodulation and therefore does not have the capability to combat inter-symbol-interference typically introduced by multi-path fading.

It is therefore desirable to provide a modernized baseband design compatible with or to retrofit these legacy systems. It is further desirable to employ advanced DSP algorithms and introduce adaptive equalization to realize coherent demodulation. It is further desirable to provide enhanced frequency offset determination capability and improved rotation angle calculation.

To enhance the speed and simplicity of hardware implementation of the rotation angle calculation, it is desirable to use shift and add operations, eliminating multiplication operations.

### SUMMARY OF THE INVENTION

A CORDIC angle calculator for a baseband IC receiver provides a CORDIC algorithm calculating processor. An input scaling means receives input data, scales the input data and provides it to the CORDIC processor. An output scaling means receives output data from the CORDIC processor and rescales the output data to provide a calculated angle. In an exemplary embodiment, the input scaling means includes means for shifting the input data for bit reduction and providing a shift signal corresponding to the input data shift and wherein the output scaling means is responsive to the shift signal.

In the exemplary embodiment, the CORDIC angle calculator incorporates an input initialization function and an Angle Accumulation Initialization function for acting on angle data larger than π/2. A 16 bit adder receives a 12 bit input X0 from the input initialization function and prior increment data stored in a first register. A shift register receives Y0 input from the input initialization function and right shifts the data n bits where n=0, 1 . . . 11 with a sign set based on a SIGN output. A second 16 bit adder receives a 12 bit input Y0 from the input initialization function and prior increment data from a second register. A second shift register receives X0 from the input initialization function and right shifts n bits for input to the second adder with its sign set based on the SIGN output. The output of the second adder is the sign output, and the sign for the first shift register output is (−1)^{sign} and the sign for the second shift register output is −(−1)^{sign}. A third shift register rescales an output of the first adder using the shift bits output from the input scaling. An angle accumulator receives input from the Angle Accumulation Initialization function and a prior sample from a second prior sample register and a new input from a CORDIC Lookup table which is unsigned. The sign of the table input to the angle accumulator is determined based on the SIGN output from the second adder with the sign determined as −(−1)^{sign}. Rounding and saturating of the output from the angle accumulator is accomplished and provides an output as a correction angle for use in carrier recovery and initial signal rotation.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of a the elements in a communications system demodulation data path employing the current invention;

FIG. 2 is a block diagram of the elements of the carrier recovery section of FIG. 1;

FIG. 3 is a block diagram of the elements of a CORDIC angle calculator incorporating the present invention;

FIG. 4 is a flow chart of the angle accumulator initialization in the angle calculator;

FIG. 5 is a flow chart of the rotator operation;

FIG. 6 is a block diagram of the elements of the rotator; and,

FIG. 7 is a flow chart of the angle accumulator initialization in the rotator.

### DETAILED DESCRIPTION OF THE INVENTION

The present invention is defined for an exemplary embodiment employed with a PHS communication system and standard (a 2G legacy mobile system). A complete description of the exemplary system is provided in copending patent application Ser. No. 60/693,457, attorney docket no. U001 100150P filed on Jun. 22, 2005 and entitled FAST CONVERGENCE ADAPTIVE EQUALIZATION IN PHS BASEBAND DEMODULATION, the disclosure of which is incorporated by reference as though fully set forth herein.

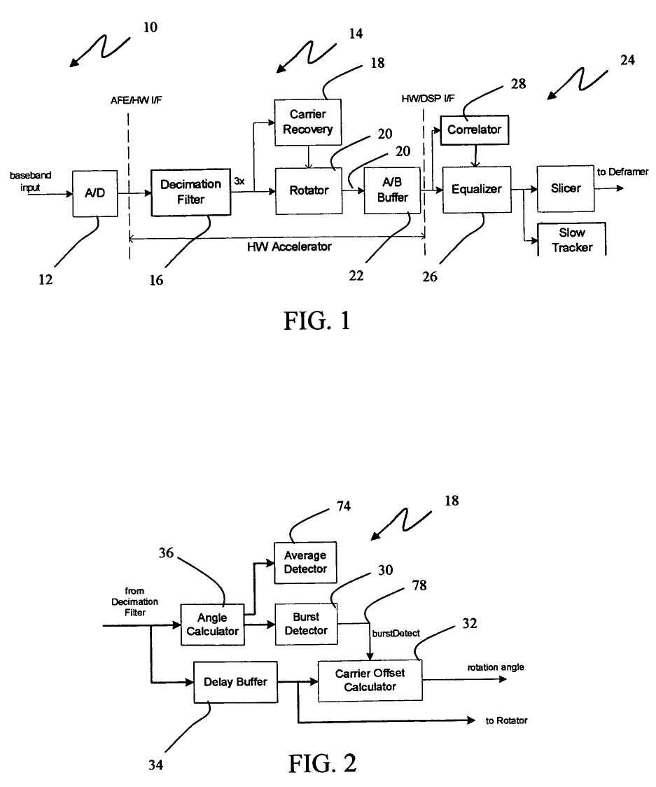

As shown in FIG. 1, a communications demodulator data path employing the present invention incorporates an analog front-end (AFE) section 10 including an analog to digital converter 12 to convert the signal from analog to digital. To improve receiver performance, the AFE includes an analog down mixer in combination with the power amplifier and analog to digital converter to improve the accuracy of phase detection.

The converted digital signal is passed to a hardware accelerator 14 and further filtered and decimated 16 to 3× symbol rate, e.g. 576 kHz. This signal first passes a Carrier Recovery block 18 and then a Rotator block 20 and then to a storage register 22 which for the embodiment disclosed herein is a dual or A/B register. The function of Carrier Recovery block is to detect the burst and estimate carrier frequency offset between received and transmitted signals. This allows the following Rotator block to compensate the carrier offset. This rotated signal is then passed to a DSP 24 with an Equalizer 26. An adaptive decision-directed equalizer is applied where the training sequence is the unique word (UW) in the burst. Therefore an accurate position of UW is required. This information is acquired via a correlation block 28. The input data is correlated with UW and therefore, after the peak of the correlation result is detected, the UW location in the burst data can be determined. This process, typically known as conventional coherent detection, is employed in the present invention even though the base-band modulation is DQPSK. Theoretically this kind of coherent detection can have 3 dB better performance than differential detection.

As for every coherent demodulator, the recovery of the carrier is most crucial. Its quality impacts the performance of the function blocks at later stages. The most widely used carrier frequency recovery scheme is automatic frequency control (AFC). However in the PHS system, the data is transmitted in burst mode, therefore the response time for AFC to be stable is relatively short, normally within a few to tens of symbols. Therefore open-loop carrier frequency estimation is employed in the present invention. Slow tracking circuitry is then applied to follow the slow varying carrier characteristics.

In the coherent demodulation of PSK signals, carrier frequency offset due to either limited oscillator precision or the Doppler effect caused by moving vehicles, can cause a significant loss in performance. In the PHS system, the system base station or cell station (CS) may have offset of up-to ±2 ppm and mobile or personal station (PS) may have offset of up-to ±5 ppm. Correcting the frequency offset in such demodulation will help improve receiver performance and relieve the stringent accuracy requirements on an oscillator and therefore reduce cost.

The Carrier Recovery block of the PHS employing the present invention has two basic functions, one is to detect a TDD (time division duplex) burst and the other is to estimate the carrier frequency offset between the received and the transmitted signal. This estimated carrier offset is employed either to drive a rotator to compensate the offset in received signal or to drive an AFC to correct frequency of the local carrier generator.

For a TDD system like PHS, the synchronization between PS and CS is extremely important as the first step in building the communication link. When the system is powered on for the first time, there is no timing information whatsoever. It is the PS's task to seek the timing information from the received air signal. Therefore for PS to acquire the timing information from CS, it needs to search for the proper indication. In PHS, the preamble signal (PR) in the control slot has appropriate characteristics to be used to detect such a burst (or slot).

As shown in FIG. 2, Carrier Recovery block 18 consists of a Burst Detector (BD) 30 and a Carrier Offset Calculator (COC) 32. The burst detect flag from BD will trigger the signals from the delay buffer 34 to pass to COC to derive the carrier offset frequency. The resulting offset is transformed to a rotation angle to pass to Rotator 20 so that the frequency offset can be compensated in the received signals. The carrier recovery block is controlled by carrier recovery control registers and can be bypassed by setting the proper register bit. A disclosure of an embodiment for the control registers is provided in copending application Ser. No. 60/766591, attorney docket no. U001 100146P entitled TDMA Controller filed Jan. 30, 2006, the disclosure of which is incorporated herein by reference as though fully set forth.

The present invention is incorporated in a CORDIC (coordinate rotation digital computer) algorithm for angle calculation in the demodulation system of the embodiment disclosed. CORDIC is an iterative solution for a wide range of functions, such as sine, cosine, tangent, arctangent, vector magnitude, etc. It is best known for its hardware implementation efficiency since it only uses shifts and adds instead of multiplications.

The CORDIC algorithm is derived from the general rotation transform,
x′=x cos(θ)−y sin(θ)=cos(θ)·(x−y·tan(θ))
y′=x sin(θ)+y cos(θ)=cos(θ)·(y+x·tan(θ))

If θ is defined as θ=arctan(1/2ⁱ), then the multiplication of tan(θ) can be reduced to a shift. An arbitrary angle rotation can be achieved by performing a series of elementary rotations. Each rotation direction is decided by dᵢ, where dᵢ=±1. The equations of a series rotations are
xᵢ₊₁=kᵢ·(xᵢ−dᵢ·yᵢ·2⁻ⁱ),
yᵢ₊₁=kᵢ·(yᵢ+dᵢ·xᵢ·2⁻ⁱ),
where kᵢ=1/\sqrt{1+2^{−2i}} and dᵢ=±1.

The accuracy of CORDIC algorithm depends on both the bit precision of the input data and the iteration times. In general, the CORDIC algorithm can produce one additional bit of accuracy if the iteration times or input bit precision are increased by one.

An angle calculator arctan(I/Q) can be realized using the following iterative equations,
xᵢ₊₁=xᵢ−dᵢ·yᵢ·2⁻ⁱ,
yᵢ₊₁=yᵢ+dᵢ·xᵢ·2⁻ⁱ,
and zᵢ₊₁=zᵢ−dᵢ·arctan(2⁻ⁱ), where dᵢ=1 if yᵢ>0, dᵢ=−1 otherwise.

The initial value of the equations are x₀=I, y₀=Q and z₀=0. Then after n iterative times, we have xₙ=Aₙ\sqrt{I²=Q²}, yₙ=0, zₙ=arctan(I/Q), where

$${A}_{n} = {\prod }_{n} \sqrt{1 + {2}^{- 2 i}} .$$

For the embodiment of the invention disclosed herein, the number of iterations is chosen as n=12 and the arctangent table employed is 12×16. The form of the table is shown in Table 1 where π can be represented as 0×10000.

TABLE 1

| Arctangent | | | Values Represented |
|---|---|---|---|
| Table (Q.16) | Bit Range | Value (unsigned) | (per π) |
| [0] | [15:0] | 16384 | Atan(1) = ¼ * π |
| [1] | [15:0] | 9672 | Atan(½) |
| [2] | [15:0] | 5110 | Atan(¼) |
| [3] | [15:0] | 2594 | Atan(⅛) |
| [4] | [15:0] | 1302 | Atan( 1/16) |
| [5] | [15:0] | 652 | Atan( 1/32) |
| [6] | [15:0] | 326 | Atan( 1/64) |
| [7] | [15:0] | 163 | Atan( 1/128) |
| [8] | [15:0] | 81 | Atan( 1/256) |
| [9] | [15:0] | 41 | Atan( 1/512) |
| [10] | [15:0] | 20 | Atan( 1/1024) |
| [11] | [15:0] | 10 | Atan( 1/2048) |

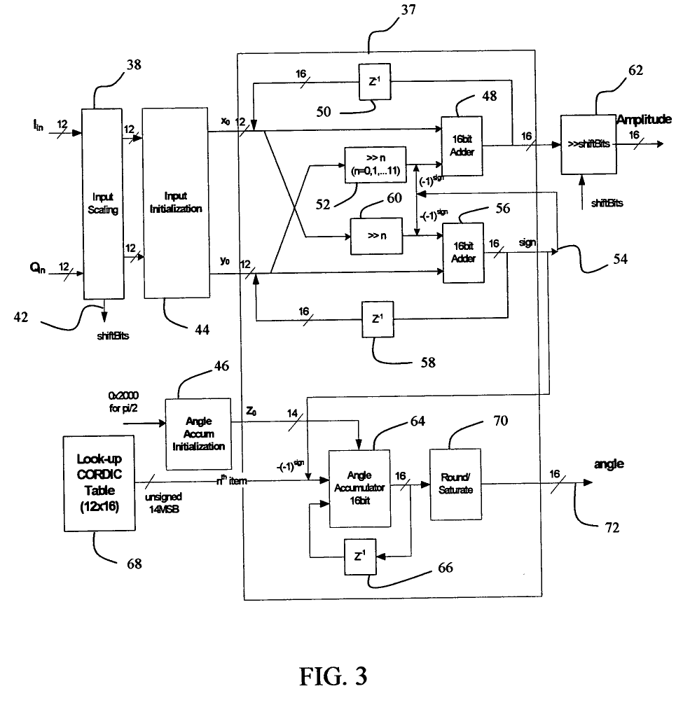

An exemplary CORDIC Angle Calculator 36 employed in the present embodiment of the invention is shown in FIG. 3. To maximize accuracy of the CORDIC 37, a scaling function 38 for the input data scales input data to its full scale of 12 bits.

The CORDIC angle calculator receives the I and Q data from the decimation filter and incorporates the scaling function for the input. The scaling function incorporates a shift register 40 to shift the I and Q data and provides a shift bits output 42 which is employed in re-scaling the amplitude output, as will be described subsequently.

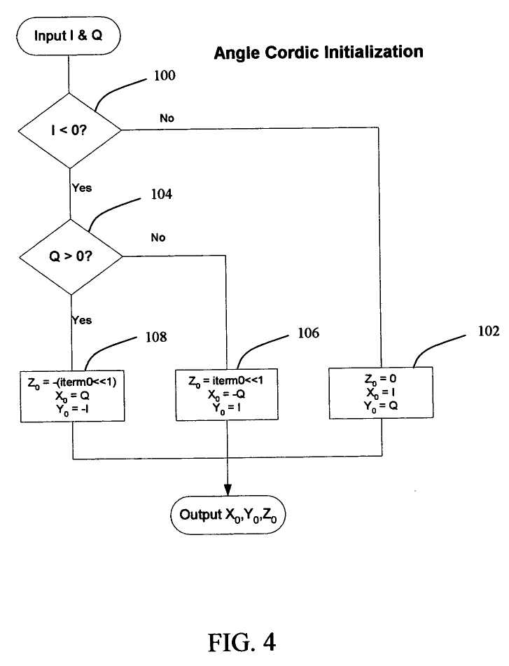

An input initialization function 44 and companion Angle Accumulation Initialization function 46 are employed for acting on angle data larger than π/2. The initialization function is accomplished as shown in FIG. 4. The input I and Q are evaluated and if I is not less than 0, block 100, the provided output is shown in block 102 as Z0=0, X0=1 and Y0=Q. If I is less than 0, the value of Q is determined, block 104, and if Q is 0 or less, the provided output is shown in block 106 as Z0 is item0 defined as π/2, or equal 2*[0] of Table 1, left shifted one bit, X0=−Q and Y0=1. If Q is greater than 0, the provided output is shown in block 108 with Z0 equal to −(item0) left shifted one bit, X0=Q and Y0=−1.

A physical embodiment of the CORDIC Angle Calculator 36 incorporates a 16 bit adder 48 receiving the 12 bit input X0 and prior increment data stored in register 50. A shift register 52 receives the Y0 input and right shifts the data n bits where n=0, 1 . . . 11 with a sign set based on the sign output 54. Similarly, a second 16 bit adder 56 receives the 12 bit input Y0 and prior increment data from register 58. A second shift register 60 receives X0 and right shifts n bits for input to the second adder, again with its sign set based on the SIGN output. The output of the second adder, sign, determines the sign for the first shift register output as (−1)^{sign} and the sign for the second shift register output as −(−1)^{sign}. The output of the first adder is rescaled in shift register 62 using the shift bits output from the input scaling. The rescaled data is then employed for calculation of the signal amplitude for further use in carrier recovery as will be described subsequently.

Actual angle calculation is achieved based on the Angle accumulator initialization as previously described which is input to the angle accumulator 64 with the prior sample stored in register 66 and the new input from the CORDIC Lookup table 68 which is unsigned. The sign of the table input to the Angle accumulator is determined based on the SIGN ouput from the second adder, previously described, with the sign determined as −(−1)^{sign}. The output from the Angle accumulator is then operated on to round and saturate 70 and output as the correction angle 72 for use in carrier recovery and initial signal rotation.

The burst detector 30 is employed to detect a TDD burst. In PHS, the PR signal in the control slot provides a suitable signature for detection. For a received in-band signal, sᵣ(t)=A(t) cos(Δω_{c}t+θ′(t)+φ)+n(t), where

$$A ( t ) = {\sum }_{k} g ( t - kT ) ,$$

g(t) is a raised-cosine pulse, Δω_{c} is the carrier offset, θ′(t) is the receiver modulation phase and φ is the fixed phase offset between transmitter and receiver, n(t) is white Gaussian noise. The phase signal of Sᵣ(t) is simply phz(t)=2πΔft+θ(t)+φ if the difference between the transmitter modulation phase and receiver modulation phase is ignored.

After a single differentiator, the phase difference becomes

phzDiff1(t)=phz(t)−phz(t−T)=2πΔfT+θ(t)−θ(t−T). The single differentiated signal is a periodic signal centered at 1/4 π+2πΔfT with period of 2T, and the phase value is within

$$[ - \frac{π}{4} , \frac{3 π}{4} ] .$$

After a double differentiator, the phase becomes phzDiff2(t)=phzDiff1(t)−phzDiff1(t−T)=θ(t)+θ(t−2T)−2θ(t−T). The double differentiated signal is a periodic signal centered at 0 and with period of 2T. The value of the signal is within [−π,π].

The burst detect algorithm is derived by taking advantage of this characteristic of PR. Let

$$sumPhase = {\sum }_{m = 0}^{M - 1} abs ( phzDiff 2 ( t - mT ) + phzDiff 2 ( t - mT - T ) ) ,$$

where M is the window length. M=16 for the embodiment described herein. The above equation can be simplified

$$\begin{matrix}sumPhase = {\sum }_{m = 0}^{M - 1} abs ( θ ( t - mT ) - θ ( t - mT - T ) - θ \\ ( t - mT - 2 T ) + θ ( t - mT - 3 T ) ) as \\ = {\sum }_{m = 0}^{M - 1} abs ( phzDiff 1 ( t - mT ) - phzDiff 1 ( t - mT - 2 T ) )\end{matrix}$$

If sumPhase is less than a burst detect threshold ThB then a burst is detected. For exemplary embodiments, ThB=3*π.

The burst detector of FIG. 2, receives the angle θ in 16 bit format from the angle detector. A moving average is then employed for burst detection.

The average detector 74 of FIG. 2 employs the amplitude output, A=\sqrt{I²+Q²}, from the CORDIC angle calculator to provide an average signal value to set a programmable gain amplifier (PGA) in the AFE so that the signals entering ADC 12 (of FIG. 1) can be in the proper range, i.e., neither too small resulting in lost precision nor too large which might potentially be clipped. Setting of the PGA gain is delicate especially in a wireless environment.

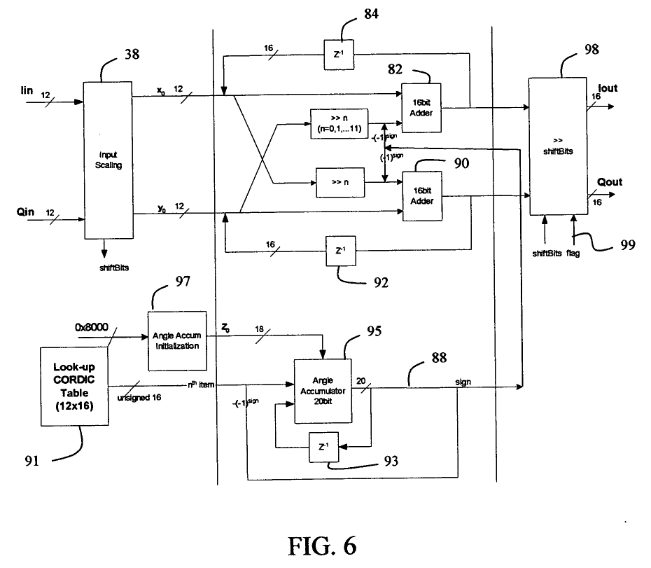

Derived amplitude from the CORDIC angle calculator is used to perform average detection. The calculated instant amplitude value is smoothed through an alpha filter E{A}ₙ=(1−α)E{A}ₙ₋₁+α·Aₙ, where α is a register. After about 20-30 symbols (60-90 samples), the average value is a good prediction of true average signal. The block diagram of an embodiment of the average detector is shown in FIG. 6.

This average detection is reset at each burst. The input to the average detector is provided by the amplitude output 76 of the CORDIC angle calculator.

Since the instant amplitude is calculated as a by-product of angle calculation, the input to the average detector is continuous during the PR searching stage. However it does not produce meaningful value since the burst boundary is not clear. Therefore the average detector is disabled during burst search. When carrier recovery enters BCCH searching mode, the burst boundary is somewhat clearer. During this period, the average detector is triggered to begin processing for a time period during every burst, and the resulting value is sent to the DSP with the burst data indicating the respective CS transmitted signal strength. The average detector is enabled and reset at beginning of every burst. After one CS is selected, the respective average value can be used to set PGA gain.

The carrier offset calculator 32 of FIG. 2 employs the open-loop carrier offset estimation algorithm used in PHS for carrier recovery. The algorithm makes use of the characteristics of the PR signal in the PHS system and directly estimates the carrier offset introduced by the oscillator and Doppler shift.

After modulation, the transmitting signal is represented as

$$s ( t ) = {\sum }_{k} {g}_{r} ( t - kT ) cos ( {ω}_{c} t + θ ( t ) ) ,$$

where gᵣ(t) is the root-square raised cosine shaping filter, and ω_{c} is the carrier frequency in radius and T is the symbol time period. θ(t) is the modulation phase. For π/4-shift DQPSK modulation in PHS, θ(t)=θ(t−T)+Δθ(t), and the relation between transmit symbol (aₖ, bₖ) and Δθ(k) is listed in Table 2

TABLE 2

| (aₖ, bₖ) | Δθ(k) |
|---|---|
| (0, 0) | π/4 |
| (0, 1) | 3π/4 |
| (1, 1) | −3π/4 |
| (1, 0) | −π/4 |

On the receiver side, a root-square raised cosine matched filter is applied and hence the base-band demodulated signal can be represented as
sᵣ(t)=A(t)cos(Δω_{c}t+θ′(t)+φ)+n(t)

where

$$A ( t ) = {\sum }_{k} g ( t - kT ) ,$$

g(t) is raised-cosine pulse, Δω_{c}=2πθf_{c} is the carrier offset, θ′(t) is the receiver modulation phase and φ is the fixed phase offset between transmitter and receiver, and n(t) is white Gaussian noise.

Let x(t)=E{sᵣ(t)sᵣ*(t−2T)}, where Sᵣ*(t) is the conjugate of sᵣ(t), resulting in
x(t)=σ_{A}e^{j[2Δωt+θ(t)-θ(t-2T)]}+N(t), where σ_{A}=E{A(t)²}, and
N(t)=E{sᵣ(t)n*(t−2T)}+E{n(t)sᵣ*(t−2T)}+E{n(t)n*(t−2T)} is the noise term and is ignored without loss of generality.

In PHS, PR is a periodic signal with a bit stream pattern of “1001”, resulting in θ(t)−θ(t−2T)=−π/2. Let x₁(t)=E{A²(t)}sin(2Δω_{c}T) and x_{Q}(t)=E{A²(t)}cos(2Δω_{c}T), where x₁(t), X_{Q}(t) are the in-phase and quadrature part of x(t), respectively.

If x₁(t) and X_{Q}(t) is being accumulated for N symbols, where N is the searching window,

$${Acq}_{i} ( k ) = {\sum }_{n = 0}^{N - 1} {x}_{l} ( {t}_{0} + {kT}_{s} + nT ) and$$

$${Acq}_{q} ( k ) = {\sum }_{n = 0}^{N - 1} {x}_{Q} ( {t}_{0} + {kT}_{s} + nT ) .$$

The amplitude is defined as Amp(k)=Acqᵢ²(k)+Acq_{q}²(k), where k=0, 1, . . . m−1 and 0≦t₀≦T is the sampling time. T₁ is the sampling period where T=mTₛ and m is the number of the sample points within a symbol period.

After a burst is detected, the carrier offset Δf_{c} can be estimated by finding max{Amp(k)} for each k=0, 1, . . . m−1, over a window length N. Let Amp(k₀)=max{Amp(k)} correspondent to each k, where A₀=A²(t₀+k₀Tₛ+nT), n=0, . . . N−1, then the carrier offset can be calculated as

$$Δ {f}_{c} = {Δω}_{c} / 2 π = \frac{1}{4 π T} {tan}^{- 1} ( \frac{{Acq}_{i} ( {k}_{0} )}{{Acq}_{q} ( {k}_{0} )} ) .$$

The Carrier offset calculator is triggered by the burst detection flag 78. I/Q data is entered into a delay buffer. For use in the present embodiment of the invention, the delay buffer employs a sliding window summing arrangement for more efficient storage. Further disclosure of the delay buffer is provided in copending patent application Ser. No. 11/306986, Attorney docket no. U001 100148, entitled Storage Efficient Sliding Window Sum, filed Jan. 18, 2006 which is incorporated by reference as though fully set forth herein.

This module can be bypassed by setting the control register. Another flag to control carrier offset calculator is an enable flag. During TCH, the carrier offset calculator is no longer working, therefore the enable flag can be set to disable to save power. The data will then merely flow through the delay buffer into the rotator.

Having now described the carrier recovery elements and returning to FIG. 1, the Rotator 20 cancels the effect of carrier frequency offset after the carrier is recovered. When Carrier Recovery module detects a burst and derives the correspondent angle due to frequency offset, the Rotator module will be activated and start rotating the input signals according to the register values.

For a complex represented input signal x=x₁+jx_{Q}, if the rotation angle is θ, then the output of the rotator is y=y₁+jy_{Q}, where y₁=x₁ cos(θ)−X_{Q} sin(θ) and y_{Q}=X₁ sin(θ)+X_{Q} cos(θ). Direct operation on the rotation involves 4 multiplications and 2 additions for each sample. Moreover, there is a calculation of sin( ) and cos( ) functions.

The CORDIC algorithm is again employed in the present invention to realize vector rotation, which reduces cost by using only shifts and adds instead of multiplications. Iteration is again selected at 12 and the size of the CORDIC table is 16×12 allowing common table use with the CORDIC angle calculator in the Carrier Recovery system.

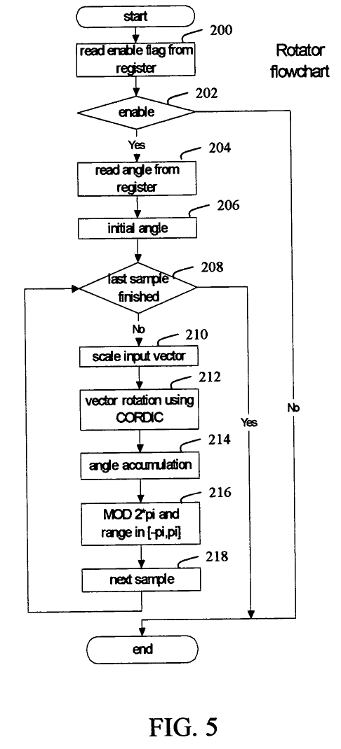

Basic operation of the rotator is again described with respect to FIG. 5 wherein the enable flag is read from the control register 200 and, if enabled 202, reads the angle from the rotation angle register 204 and sets the initial angle 206, as will be described in greater detail subsequently. If the last sample is not finished 208, the input vector is scaled 210 and the vector rotation is accomplished using the CORDIC 212. The angle is accumulated 214 in basic bit form and as modulo 2π from −π to π and the next angle table address is generated 216 and the next sample processed 218. For an exemplary embodiment, the phase is signed 17 bit data and the accumulator is 18 bits in width. The operation which occurs is

| | |
|---|---|
| Phacc += phase_in | //accumulator |
| Phacc = phacc & 0x1ffff | //select 17 bits |

If (phacc > π) {Phacc = ((−1)<<17) | phacc //mode}

12 cycles are required for one data rotation in the current embodiment based on the input signal 12 bit width.

A physical implementation of the CORDIC is shown in FIG. 6. I and Q input are again provided to an input scaling function 80 with a ShftBits output to for subsequent rescaling. A 16 bit adder 82 receiving the 12 bit input X0 and prior increment data stored in register 84. A shift register 86 receives the Y0 input and right shifts the data n bits where n=0, 1 . . . 11 with a sign set based on the SIGN output 88. Similarly, a second 16 bit adder 90 receives the 12 bit input Y0 and prior increment data from register 92. A second shift register 96 receives X0 and right shifts n bits for input to the second adder, again with its sign set based on the SIGN output. SIGN determines the sign for the first shift register output as −(−1)^{sign} and the sign for the second shift register output as (−1)^{sign}. The outputs of the first adder and second adder are rescaled in shift register 98 using the ShftBits output from the input scaling. A FLAG 99 based on the angle accumulator initialization, described previously, is output from the Angle Accumulation Initialization function. FLAG is 1 when the input angle >pi/2, FLAG is −1 when the input angle <−pi/2, otherwise, FLAG is 0. The rescaled data is then the output I and Q for data communication.

SIGN calculation is achieved based on input θ from the Rotation Angle Register with an angle accumulator initialization 97, described in detail subsequently, which is input to angle accumulator 95 with the prior sample stored in register 93 and the new input from the CORDIC Lookup table 91 which is unsigned. The sign of the table input to the angle accumulator is determined based on the SIGN ouput from angle accumulator, with the sign determined as −(−1)^{sign}. The output from the angle accumulator also provides the SIGN for operation in the first and second adder as previously described.

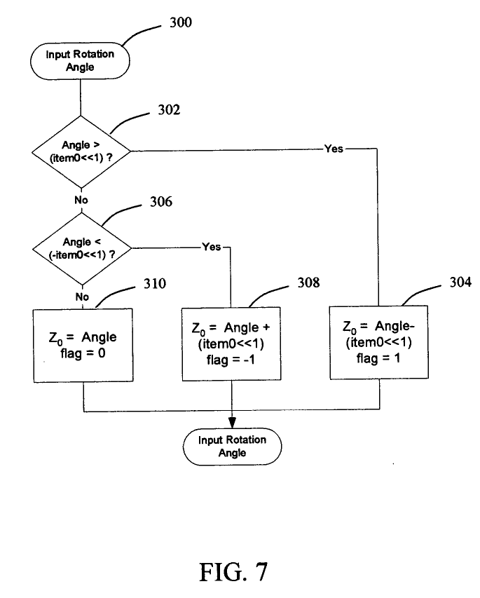

The Angle Accumulator Initialization for the CORDIC Rotator is shown in FIG. 7. The rotation angle, θ, is input 300 and if the angle is greater than item0 shifted left one bit 302, the resulting Z0 input 304 is the input angle, θ, minus item0 left shifted one bit and FLAG is set to one. If the input angle is less than −item0 left shifted one bit 306, the resulting Z0 input 308 is the input angle plus item0 left shifted one bit and FLAG is set to −1. Otherwise, Z0 is set equal to the input angle, θ, and FLAG is set to 0 310.

For each TDD burst, the initial phase is unknown and therefore the initial phase, PR and UW are unknown due to π/4−DQPSK modulation. Let r(t)=a(t)e^{j2πΔft+φ(t)+θ}^{₀}^{+θ}^{ₙ}^{(t)} be received complex signal, where α(t) is the envelope, φ(t) is the symbol phase provided the initial phase is 0. And θ₀ is the initial phase, θₙ(t) is the noise phase.

After the first rotator, the initial phase θ₀ and estimated frequency offset phase 2πΔft are removed, provided that θ₀ can be derived which will be described subsequently, we have r1(t)=r(t)*e^{-j(θ}^{₀}^{+2πΔ\hat{f}t)}=α(t)e^{j(φ(t)+2πΔf}^{_{E}}^{t+θ}^{ₙ}^{(t))}, where Δf_{E} is the uncorrected residue offset.

r2(t) is the signal after the information-bearing phase θ(t) is removed, r2(t)=r1(t)*e^{-φ(t)}=α(t)e^{j(2πΔf}^{ₑ}^{t+θ}^{ₙ}^{(t))}.

The quadrature part of r2(t) is therefore r2q(t)=α(t) sin(2πΔf_{E}t+θₙ(t)). Properly choosing an average window can smooth out the noise phase. A smoothing window of 6 symbols is employed in the embodiment of the invention disclosed herein. Therefore we have

$$sumq ( t ) = {\sum }_{n = 0}^{5} r 2 q ( t + nT ) .$$

The frequency offset adjustment is done according to the differential of sumq(t).

θ₀ can be derived based on UW which is detected by correlation. corr(t)=r(t)*e^{-jφ}^{_{uw}}^{(t)}=α(t)e^{j(2πΔft+φ}^{_{uw}}^{(t)+θ}^{₀}^{+θ}^{ₙ}^{(t))}* e^{-jφ(t)}=α(t)e^{j(2πΔft+θ}^{₀}^{+θ}^{ₙ}^{(t))}.

If Δf is small enough to be ignored, then we have,

$$E [ corr ( t ) ] = {\sum }_{n = 0}^{N} corr ( t + n T ) = N * a ( t ) {ⅇ}^{{jθ}_{0}} .$$

A slow tracker is implemented in the present embodiment described as shown in FIG. 2. The slow tracking frequency offset is provided to the rotation angle register as θ during the communication phase.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A CORDIC angle calculator for a baseband IC receiver comprising:
an input initialization function;
an Angle Accumulation Initialization function for acting on angle data larger than π/2;
means for calculating a CORDIC algorithm receiving data from the input initialization function and Angle Accumulation Initialization function;
an input scaling means receiving input data, scaling said input data and providing said input data to the input initialization function; and,
an output scaling means receiving output data from the calculating means and rescaling said output data to provide an amplitude and a calculated angle.

2. A CORDIC angle calculator as defined in claim 1 wherein the input scaling means includes means for shifting the input data for bit reduction and providing a shift signal corresponding to the input data shift and wherein the output scaling means is responsive to the shift signal.

3. A CORDIC angle calculator as defined in claim 1 wherein the calculating means comprises:
a 16 bit adder receiving a 12 bit input X0 from the input initialization function and prior increment data stored in a first register;
a shift register receiving Y0 input from the input initialization function and right shifting the data n bits where n=0, 1 . . . 11 with a sign set based on a SIGN output;
a second 16 bit adder receiving a 12 bit input Y0 from the input initialization function and prior increment data from a second register;
a second shift register receiving X0 from the input initialization function and right shifting n bits for input to the second adder with its sign set based on the SIGN output;
wherein the output of the second adder is the sign output, and the sign for the first shift register output is (−1)^{sign} and the sign for the second shift register output is −(−1)^{sign};
a third shift register rescaling an output of the first adder using the shift bits output from the input scaling;
an angle accumulator receiving input from the Angle Accumulation Initialization function and a prior sample from a second prior sample register and a new input from a CORDIC Lookup table which is unsigned;
wherein, the sign of the table input to the angle accumulator is determined based on the SIGN output from the second adder with the sign determined as −(−1)^{sign}
means for rounding and saturating the output from the angle accumulator and providing an output as a correction angle for use in carrier recovery and initial signal rotation.

4. A CORDIC angle calculator as defined in claim 3 wherein the input initialization function comprises:
means for determining if I is not less than 0;
output means responsive to a positive result in the determining means and providing Z0=0, X0=1 and Y0=Q;
second means for determining if Q is 0 or less responsive to a negative result in the determining means;
second output means responsive to a positive result in the second determining means and providing Z0 is item0 defined as π/2 left shifted one bit, X0=−Q and Y0=1; and
a third output means responsive to a negative result in the seond determining means and providing Z0 equal to −π/2 left shifted one bit, X0=Q and Y0=−1.

5. A CORDIC angle calculator as defined in claim 3 wherein the Angle Accumulation Initialization function comprises:
means for inputting a rotation angle, θ;
means for determining if the angle is greater than item0 shifted left one bit;
means for providing a Z0 input as the input angle, θ, minus item0 left shifted one bit and FLAG is set to one in response to a positive result from the determining means;
second means for determining if the input angle is less than −item0 left shifted one bit;
second means for providing a Z0 input as the input angle plus item0 left shifted one bit and FLAG is set to −1 responsive to a positive result from the second determining means; and,
third means for providing a Z0 input set equal to the input angle, θ, and FLAG is set to 0 responsive to t negative result from the second determining means.

6. A CORDIC angle calculator as defined in claims 1 further comprising an average detector.

7. A CORDIC angle calculator as defined in claim 6 wherein the average detector includes an a filter register.

8. A CORDIC rotator for a baseband IC receiver comprising:
means for calculating a CORDIC algorithm;
an input scaling means receiving input data, scaling said input data and providing said input data to the calculating means; and,
an output scaling means receiving output data from the calculating means and rescaling said output data to provide a calculated angle.

9. A CORDIC rotator as defined in claim 8 wherein the calculating means comprises:
a 16 bit adder receiving a 12 bit input X0 from the input scaling means and prior increment data stored in a first register, said input scaling means providing a shiftbits output;
a first shift register receiving a Y0 input and right shifting the data n bits where n=0, 1 . . . 11 with a sign set based on a SIGN output;
a second 16 bit adder receiving a 12 bit input Y0 from the input scaling means and prior increment data from a second register;
a second shift register receiving X0 and right shifting n bits for input to the second adder with a sign set based on the SIGN output;
SIGN means for determining the sign for the first shift register output as −(−1)^{sign} and the sign for the second shift register output as (−1)^{sign};
wherein the outputs of the first adder and second adder are rescaled in the output scaling means using the shiftbits output from the input scaling means;
a FLAG input to said resealing means based on an angle accumulator initialization, output from an Angle Accumulation Initialization function, said FLAG equal to 1 when the input angle>pi/2 and equal to −1 when the input angle<-pi/2, otherwise, FLAG equal 0, rescaled data output from said rescaling means for data communication;
said SIGN means calculation achieved based on input θ from a Rotation Angle Register with a second input from an angle accumulator initialization means to an angle accumulator with the prior sample stored in a second register and a new input from a CORDIC Lookup table which is unsigned.;
said SIGN output from the angle accumulator further determining, the sign of the table input to the angle accumulator with the sign determined as −(−1)^{sign}.

10. A CORDIC rotator as defined in claim 9 wherein the angle accumulator initialization means comprises:
a first means determining if the rotation angle, θ, is greater than item0 shifted left one bit;
a means for providing a resulting Z0 input as the input angle, θ, minus item0 left shifted one bit and FLAG is set to one based on a positive result from the first determining means;
a second means for determining if the input angle is less than −item0 left shifted one bit;
a second means for providing a Z0 input as the input angle plus item0 left shifted one bit and FLAG is set to −1 based on a positive result from the second determining means; and,
a third means for providing a Z0 input as the input angle, θ, and FLAG is set to 0 responsive to a negative result from the second determining means.

11. A method for calculating rotation angle for frequency offset determination in a signal demodulator comprising the steps of:
scaling input data by shifting the input data for bit reduction and providing a shift signal corresponding to an input data shift;
calculating a CORDIC algorithm by
providing an input initialization function and an Angle Accumulation Initialization function for acting on angle data larger than π/2;
receiving a 12 bit input X0 from the input initialization function and prior increment data stored in a first register in a 16 bit adder;
receiving Y0 input from the input initialization function in a shift register and right shifting the data n bits where n=0, 1 . . . 11 with a sign set based on a SIGN output;
receiving a 12 bit input Y0 from the input initialization function and prior increment data from a second register in a second 16 bit adder;
receiving X0 from the input initialization function in a second shift register and right shifting n bits for input to the second adder with its sign set based on the SIGN output;
wherein the output of the second adder is the sign output, and the sign for the first shift register output is (−1)^{sign} and the sign for the second shift register output is −(−1)^{sign};
rescaling an output of the first adder in a third shift register using the shift bits output from the input scaling;
receiving input from the Angle Accumulation Initialization function and a prior sample from a second prior sample register and a new input from a CORDIC Lookup table which is unsigned in an angle accumulator;
wherein, the sign of the table input to the angle accumulator is determined based on the SIGN output from the second adder with the sign determined as −(−1)^{sign};
rounding and saturating the output from the angle accumulator and providing an output as a correction angle for use in carrier recovery and initial signal rotation; and,
receiving as output data from the calculated CORDIC algorithm and rescaling said output data to provide a calculated angle.

12. A method as defined in claim 11 wherein the input initialization function is accomplished by the steps of:
determining first if I is not less than 0;
providing as a first output Z0=0, X0=1 and Y0=Q responsive to a positive result;
determining second if Q is 0 or less responsive to a negative result in the first determination;
providing as a second output Z0 is item0 defined as π/2 left shifted one bit, X0=−Q and Y0=1 responsive to a positive result in the second determination; and
providing as a third output Z0 equal to −π/2 left shifted one bit, X0=Q and Y0=−1 responsive to a negative result in the second determination.

13. A method as defined in claim 11 wherein the Angle Accumulation Initialization function is accomplished by the steps of:
inputting a rotation angle, θ;
determining first if the angle is greater than item0 shifted left one bit;
providing a Z0 input as the input angle, θ, minus item0 left shifted one bit and FLAG is set to one in response to a positive result from the first determination;
determining second if the input angle is less than −item0 left shifted one bit;
providing a Z0 input as the input angle plus item0 left shifted one bit and FLAG is set to −1 responsive to a positive result from the second determination; and,
providing a Z0 input set equal to the input angle, θ, and FLAG is set to 0 responsive to a negative result from the second determination.
